(19) United States
(12) Patent Application Publication
(10) Pub. No.: US 2013/0325867 A1
(43) Pub. Date: Dec. 5, 2013

(54) IDE INTEGRATED CATALOG AND DDIC-BRIDGE FOR IN-MEMORY DATABASE VIEWS

(71) Applicants: 69190 Kemmler, Bonningheim (DE); Torsten Kamenz, Wiesloch (DE)

(72) Inventors: 69190 Kemmler, Bonningheim (DE); Torsten Kamenz, Wiesloch (DE)

(73) Assignee: SAP AG, Walldorf (DE)

(21) Appl. No.: 13/487,717

(22) Filed: Jun. 4, 2012

(51) Int. Cl. G06F 17/30

(52) U.S. Cl. 707/740; 707/E17.046

(57) ABSTRACT

The disclosure generally describes computer-implemented methods, software, and systems for providing a homogeneous data model based on in-memory database views. One computer-implemented method includes creating an application view field associated with an application view, indicating a base database field in a base database table for the created application view field, collecting additional information associated with the indicated base database field, determining at least a data element and a domain associated with the indicated base database field using the collected additional information, determining, by operation of a computer using the collected additional information, that multiple determined catalog entries associated with the indicated base database field exist in a catalog, and proposing names for the application view field, wherein the proposed names are presented from most specific to least specific.

### TECHNICAL FIELD

The present disclosure relates to computer-implemented methods, software, and systems for providing a homogeneous data model based on in-memory database views.

### BACKGROUND

In a business application data model, data about a business application object is often distributed among conventional database tables. An application-dependent database view, or application view, may be defined by specifying a combination of database tables and/or fields. The defined application view allows the viewing of combined data applicable to the business application and is useful for various operations related to the business application data model, for example analytics. In a distributed business application computing environment, various database tables and/or fields may have inconsistent and/or cryptic names even if storing the same data. Created application views based on the inconsistent and/or cryptic names are difficult to understand and cannot provide universal applicability for operations across all application views.

### SUMMARY

The present disclosure relates to computer-implemented methods, software, and systems for providing a homogeneous data model based on in-memory database views. One computer-implemented method includes creating an application view field associated with an application view, indicating a base database field in a base database table for the created application view field, collecting additional information associated with the indicated base database field, determining at least a data element and a domain associated with the indicated base database field using the collected additional information, determining, by operation of a computer using the collected additional information, that multiple determined catalog entries associated with the indicated base database field exist in a catalog, and proposing names for the application view field, wherein the proposed names are presented from most specific to least specific.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features:

In a first aspect, combinable with the general implementation, the collected additional information includes at least one of a name, a data element assigned to the indicated base database field name, or a domain assigned to the data element.

In a second aspect, combinable with any of the previous aspects, the multiple determined catalog entries include a catalog entry for more than one of a domain, a database field, or a database element.

In third aspect, combinable with any of the previous aspects, where, for the proposed names, most specific to least specific is in an order of field in view, field in table, data element, and domain.

A fourth aspect, combinable with any of the previous aspects, further comprising choosing an applicable proposed name from the proposed names for the created application view field.

In a fifth aspect, combinable with any of the previous aspects, the most specific proposed name is chosen as the applicable proposed name.

A sixth aspect, combinable with any of the previous aspects, further comprising applying the chosen proposed name to the created application view field.

The subject matter described in this specification can be implemented in particular implementations so as to realize one or more of the following advantages. First, a catalog of application view fields and associated data linking the application view fields to actual database implementation details allows for automatic proposal of names for new application view fields. Further, the automatic naming functionality helps to ensure consistent, non-duplicative, and easily understood naming of the application view fields, providing universal applicability of the application view fields across multiple application views forming a homogenous data model. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for providing a homogeneous data model based on in-memory database views.

FIG. 2 is a block diagram illustrating an application-dependent database view (application view).

FIG. 3 is a block diagram illustrating a catalog and catalog entries.

FIG. 4 is a block diagram illustrating an enterprise server.

FIG. 5 is a block diagram illustrating a client.

FIG. 6 is a flow chart for providing a homogeneous data model based on in-memory database views.

Like reference numbers and designations in the various drawings indicate like elements.

### DETAILED DESCRIPTION

The disclosure generally describes computer-implemented methods, software, and systems for providing a homogeneous data model based on in-memory database views.

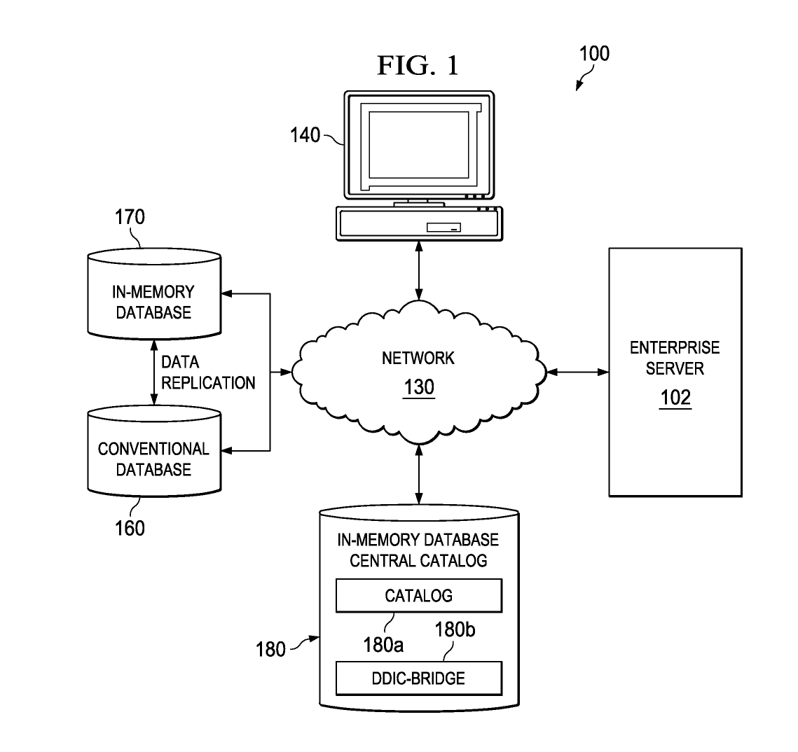

FIG. 1 illustrates an example distributed computing system 100 operable to provide a homogeneous data model based on in-memory database views. Specifically, the illustrated example distributed computing system 100 includes or is communicably coupled with a enterprise server 102, a client 140, and a conventional database 160, an in-memory database 170, and an in-memory database central catalog 180 that communicate across a network 130. At a high level, the enterprise server 102 provides business application or other services in an organization's system landscape. Generally, through a graphical user interface (GUI), a user, for example a client 140 is provided with an efficient and user-friendly presentation of data provided by or communicated within the example distributed computing system 100 and the ability to perform operations within the example distributed computing system 100.

In some implementations, the in-memory database 170 is used as a primary database to the enterprise server 102. In this implementation, the client 140 interfaces with the in-memory database 170 and with the in-memory database central catalog 180. This implementations allows for the direct analytical access to the data stored in the enterprise server using analytical tools working with the in-memory database 170. In other implementations, the in-memory database 170 is used as a secondary database side-by-side with a conventional database 160 that interfaces with the enterprise server 102. In this implementation, the client 140 interfaces with the conventional database 160, the in-memory database 170, and the in-memory database central catalog 180. The data needed for analytical operations is replicated in real-time or near real-time to the in-memory database 170. The analytical applications are executed against the in-memory database 170 and the existing data for the enterprise server 102 on the conventional database 160 is not affected. As will be appreciated to those skilled in the art, other configurations of the enterprise server 102, client 140, conventional database 160, in-memory database 170, and in-memory database central catalog 180 are possible without departing from the scope of this disclosure.

The example distributed computing system 100 includes a conventional database 160 containing data applicable to, in some implementations, a business application (described below) associated with the enterprise server 102. The conventional database 160 primarily relies on non-volatile magnetic, optical, removable, or other suitable non-electronic memory, for storage, retrieval, and processing of data. Although illustrated as a stand-alone component of the example distributed computing system 100, conventional database 160 may be integrated wholly or in part with any other component of the example distributed computing system 100. The conventional database 160 may also take the form of a physical and/or virtual database.

The example distributed computing system 100 also includes an in-memory database 170. The in-memory database 170 is a high-performance database management system (DBMS) that primarily relies on volatile electronic memory, such as random access memory (RAM), as opposed to magnetic, optical, removable, or other suitable non-electronic memory, for storage, retrieval, and processing of data. The reliance on electronic memory allows, in some implementations, for near-real-time aggregation, replication, synchronization, and processing of data. In some implementations, a persistency layer ensures that a copy of the in-memory database is maintained on non-volatile magnetic, optical, removable, or other suitable non-electronic memory in the event of a power or other system failure in order to allow recovery of the in-memory database. In some implementations, the in-memory database 170 can be replicated to the conventional database 160 for backup purposes. In some implementations, data from the conventional database 160 can be replicated to and used from the in-memory database 170.

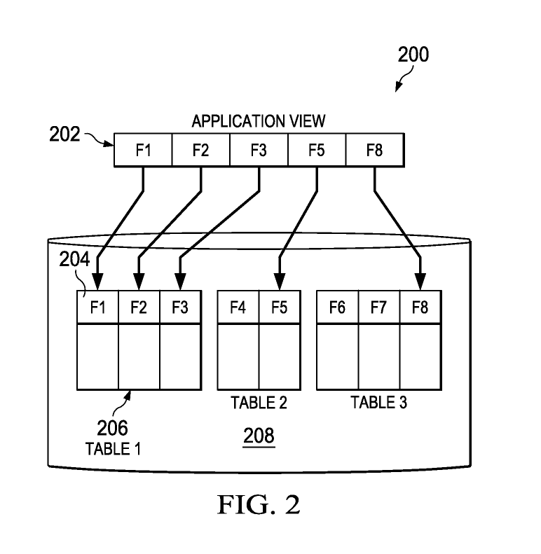

Turning now to FIG. 2, FIG. 2 is a block diagram 200 illustrating an example application-dependent database view, or application view. The example application view 202 is made up of specified fields 204, for example F1, F2, etc., from database tables 206, for example Table 1, Table 2, etc., of one or more databases 208 that are associated with a business application. The defined application view 202 allows the viewing of combined fields 204 (and associated data) applicable to the business application. The application view 202 is a virtual database table composed of the result set of a query or map and reduce functions. Unlike ordinary database tables 206, a model of the application view 202 does not form part of the physical schema of the one or more databases 208 and is a dynamic, virtual table computed or collated from the one or more databases 208. A runtime object generated from the model of the application view is, however, a part of the physical database schema in a form of a database view. In some implementations, the database view may be a column view. Changing the data associated with a field 204 in a database table 206 alters the data shown in subsequent invocations of the application view 202.

Analytical operations for enterprise server business applications interfacing with an in-memory database require a data model that possesses consistently named and easily understood application view fields. In order to provide efficient and useful analytical operations, the data model will be represented by multiple generated application views. To ensure consistent naming and understanding, the names of application view fields associated with the multiple application views need to project the context and content of what data the application view field represents. For example, an application view field associated with a business application that holds the identification of an “EmployeeID,” “CostCenter,” or any other business object should be named similarly and consistently named across all application views associated with the business application using the application view field “EmployeeID,” “CostCenter,” etc. For example, naming the application view field, “EmpID,” “CCtr,” etc. is not as conducive to understanding as a fuller and more complete spelling such as “EmployeeID” and “CostCenter.”

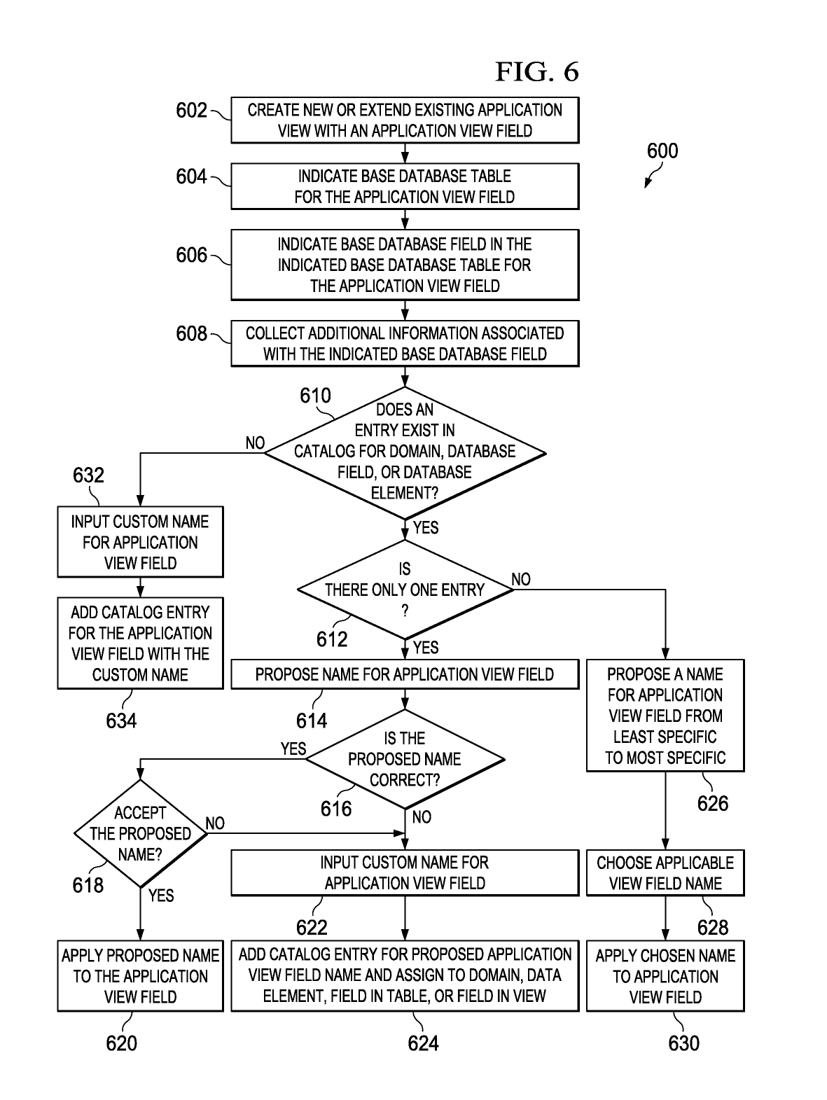

Returning to FIG. 1, the example distributed computing system 100 includes an in-memory database central catalog (DCC) 180. In some implementations, the DCC 180 contains a catalog 180a database table and a data dictionary (DDIC)-bridge 180b database table. In other implementations, the catalog 180a and the DDIC-bridge 180b are combined. In some implementations, there is a only single DCC 180 in the example distributed computing system 100 communicably coupled to other components of the example distributed computing system 100 using network 130. The catalog 180a contains application view fields and ensures consistent and reusable naming for the application view fields. For example, a catalog 180a application view field entry for “EmployeeID” may be used in multiple application views to refer to the same application view field name as well as being easy understandable. In some implementations, entries in the catalog 180a and/or the DDIC-bridge 180b can be created, modified, and/or deleted by experts with a semantic understanding of a business application. These entries can then be appropriately used by the method described in FIG. 6 below.

The DDIC-bridge 180b links all entries in the catalog, for example “EmployeeID” to actual database entities, for example an “EmpID” database column name. The DDIC-bridge 180b may contain, among other data values, links to database domains, data elements, and/or database table fields available on the in-memory database 170. The DDIC-bridge 180b provides data necessary to ensure non-duplicative naming of all application view field names.

A view field naming application/service (described below) is provided to analyze the underlying database entity characteristics that an application view field is based on, the catalog 180a, and the DDIC-bridge 180b data values associated with particular catalog 180a entries to propose an external name to use with the application view field. For example, assuming a database table with a column name of “Pers” that is known to contain the last name of a person, it is necessary to check whether an entry in the catalog 180a already is mapped to this actual column name. At a high-level, it is difficult without actual knowledge to know how to search the catalog 180a to determine whether there is already an appropriate entry for this column name. For example, a catalog 180a entry for “Person” may not represent the last name of a person, but instead an identification number issued by the country of residence.

As application view field names in the catalog 180a are typically derived from corresponding database table field names, this relationship between the catalog 180a entry and the actual database table field name provides a link, the DDIC-bridge 180b, between the catalog 180a entry and the underlying database domains, data elements, and/or database table fields.

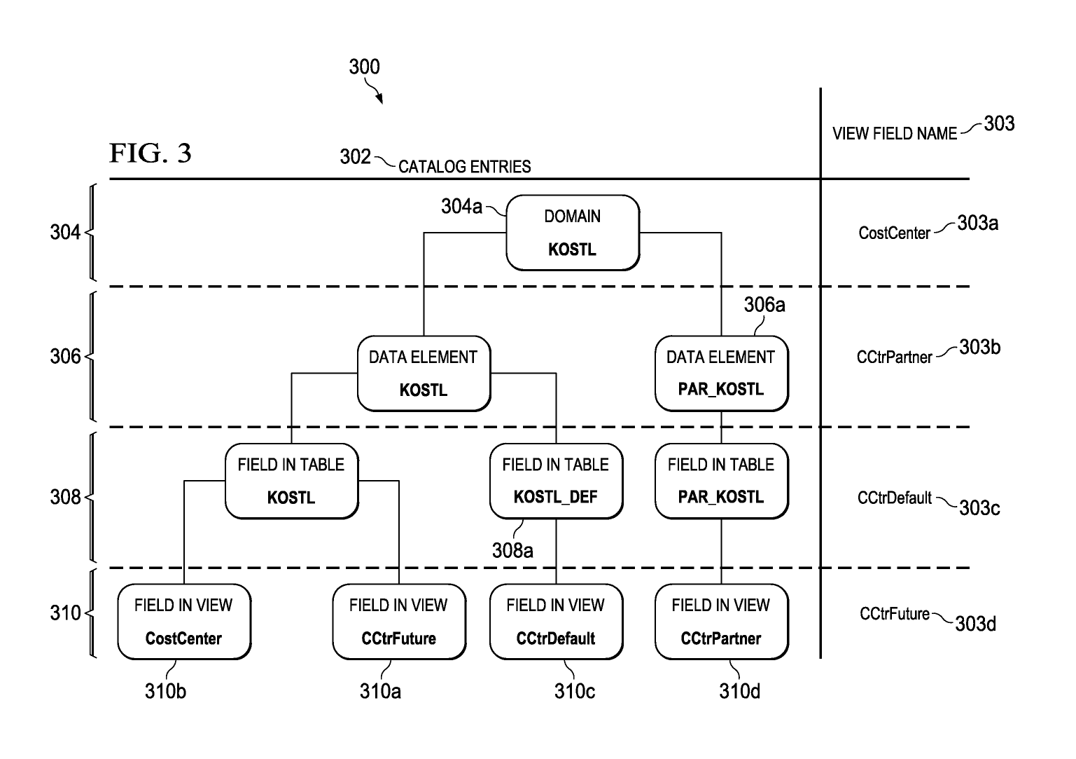

Turning now to FIG. 3, FIG. 3 is a block diagram 300 illustrating catalog entries 302 associated with a catalog 180a. Catalog entries 320 include both a proposed application field name 303 and a relationship to DDIC elements (e.g., 304-310). As shown, the DDIC elements are hierarchically related from domain 304 indicating the highest level (more generic), next to data element 306, then to field in table 308, and finally to field in view 310 (least generic). The proposed view field names (e.g., 303a-303d) form part of a catalog entry. The relationship between the proposed view field names 303 and the DDIC elements is shown horizontally. For example, proposed view field name CostCenter 303a is refers to domain KOSTL 304a, CCtrPartner 303b refers to data element PAR_KOSTL 306a, CCtrDefault 303c refers to field in table KOSTL_DEF 308a of a database table, and CCtrFuture 303d refers to field in view CCtrDefault 310a of an application view.

A domain is a development object which describes the semantic meaning of a business entity. For example:

Name of DDIC Domain: KOSTL

Short Description Cost Center

Data Type Char 10

For assignments on the domain level 304, a catalog entry 302 is potentially relevant for all application view fields which refer to a table field which refers to a data element which refers to a domain. For example, if the domain “KOSTL” 304a is referred to in a generated/extended application view, the view field naming application/service might propose that the “CostCenter” 303a view field name be used based on data associated with the catalog entry 302. Note that a reference to the domain level 304 is relatively generic and will not properly apply for all application view fields.

A data element refers to a domain and inherits the data type of the associated domain but has its own description. In some implantations, the data element is a specialization of an associated domain. For example:

Name of DDIC Data Element: PAR_KOSTL

Short Description: Cost Center of a Business Partner

Assigned DDIC Domain: KOSTL

For assignments on the data element level 306, a catalog entry 302 is potentially relevant for all application view fields which refer to table fields of a data element. For example, if the data element 306a “PAR_KOSTL” is referred to in a generated/extended application view, the view field naming application/service might propose that the “CCtrPartner” view field name 303b be used based on data associated with the catalog entry 302. In some implementations, this is the level that most “hits” are expected to take place.

A table field refers to a data element and inherits the semantic meaning and type of the associated data element. The type of the associated data element is also the type of the domain assigned to the data element. For assignments on the table field level 308, a catalog entry 302 is generated when the concrete usage differs from an entry at the data element level 306. This may occur, for example, when a data element used for a table field is no longer correct. An example of this would be if the type of records stored in the table field was changed. In this case, a view field name could be used to refer to the current usage of the table field. A catalog entry 302 at this level is potentially relevant for all application view fields which refer to the specific table fields. For example, if the field in table 308a “KOSTL_DEF” is referred to in a generated/extended application view, the view field naming application/service might propose that the “CCtrDefault” view field name 303c be used based on data associated with the catalog entry 302. Note that in this example, hierarchically, there is no catalog entry 302 for the data element ancestor of the field in table 308a catalog entry 302.

A field in view, which is the same as an application view field, refers to a table field and inherits the semantic meaning and type of the associated table field. For assignments on the field in table level 310, a catalog entry 302 is generated when none of the prior more generic naming proposals could be made because the application view field possesses a meaning differing from even the meaning of a potential field in a table level catalog entry 302. This level of entry may be needed when calculated fields are used. Calculated fields are a special type of database field allowing the generation of information that can change when other data elements change. The value of the calculated field is not stored within a database record, but is instead calculated or computed using a specific formula based on the values of other database fields within that record. The formula may contain values from other fields, constants, and results of other formulas or functions. A field in view may also be used when a data element used for a table field is too generic for a specific usage in a field in view. For example, for a table field referring to PAR_KOSTL, an example cost center of a business partner, the field in view that is referring to the table field may select the suppliers, a sub-group of the example business partners. In this case, the correct name for the associated view field name associated with the field in view should be CCtrSupplier and not CCtrPartner. A reuse of a catalog entry 302 at the field in field in view level 310 is unlikely, but a catalog entry 302 is made to ensure the reservation of the applicable name and to avoid a duplicative use of the applicable name. For example, if the field in view 310a “CCtrFuture” is referred to in a generated/extended application view, the view field naming application/service might propose that the “CCtrFuture” view field name 303d be used based on data associated with the catalog entry 302.

Not all domains, data elements, field in tables, or fields in view will get a specific catalog entry 302 in the catalog 180a. If a catalog entry 302 on the domain level 304 is available, it is likely that this entry applies for many data elements assigned to that domain and a specific catalog entry 302 for a data element, field in table, and field in view are not needed. The same is true for catalog entries 302 at the data element 306 level and field in table 308 level. Generally, an applicable catalog entry 320 at a higher level (more generic) precludes the necessity of a specific catalog entry 302 a lower level (less generic). For example, the field in view 310b catalog entry 302 takes the name proposed view name “CostCenter” 303a associated with the domain “KOSTL” 304a catalog entry 302 as there is not a more specific catalog entry 302 on the data element 306 or field in table 308 levels. Note that there is a proposed view name 303 for the field in view 310 catalog entry 302 is unnecessary as the name for the field in view 310b was taken from the domain 304a view name determination. Similarly, field in view 310c takes the name “CCtrDefault” from the field in table 308a catalog entry 302 and field in table 310d takes the name “CCtrPartner” from the data element 306a catalog entry 302.

In some implementations, the catalog 180a and DDIC-bridge 180b could be structured in the following way:
Name View Field: holds the name of the view field name.
Description (optional): holds a description of the semantic meaning of the view field name, for example “CCtrDefault is the default cost center which becomes relevant when no specific cost center is entered.”
Responsible/Contact: holds the developer(s) responsible for this entry and contact information to allow contact in case of questions.
Application Area: holds the business area to which the view field name belongs.
DDIC Source Domain in ABAP (optional): DDIC Bridge to a DDIC domain
DDIC Source Data Element in ABAP (optional): DDIC Bridge to a DDIC data element
DDIC Source Table (optional) (in case that a Glossary Entry is specific for field of a table and not generally fitting to a Data Element or Domain (general approval has not been given)): DDIC Bridge to a DDIC table
DDIC Source Table Field (optional): holds the name of the field of the DDIC table in case of a DDIC Bridge to a DDIC table.
Name Source GDT (‘no’; ‘yes, without changes’; ‘yes, with minor changes’) (optional): holds an indicator of whether the name of view field was derived from a Global Data Type.
Name Source GDT Name (optional): holds the name of the corresponding Global Data Type if available.
Name Source GDT Link (optional): holds a link to a description of a Global Data Type if available
Name Source Data Element field label (‘no’; ‘yes, without changes’; ‘yes, with minor changes’): holds an indicator of whether the name of the view field was derived from the label of a data element.
Approval State (‘new’; ‘approved’; . . . ): holds an indicator of whether the view field name is already approved.
Approval Date (optional)
Approver (optional)

In some implementations, each catalog entry may have associated with it the above-described data fields. In these implementations, however, only applicable data fields for each catalog entry would be used. For example, if the catalog entry is at the domain level, the data fields for data element and tables are not applicable and, in some implementations, these data fields may not be used, contain NULL values, etc.

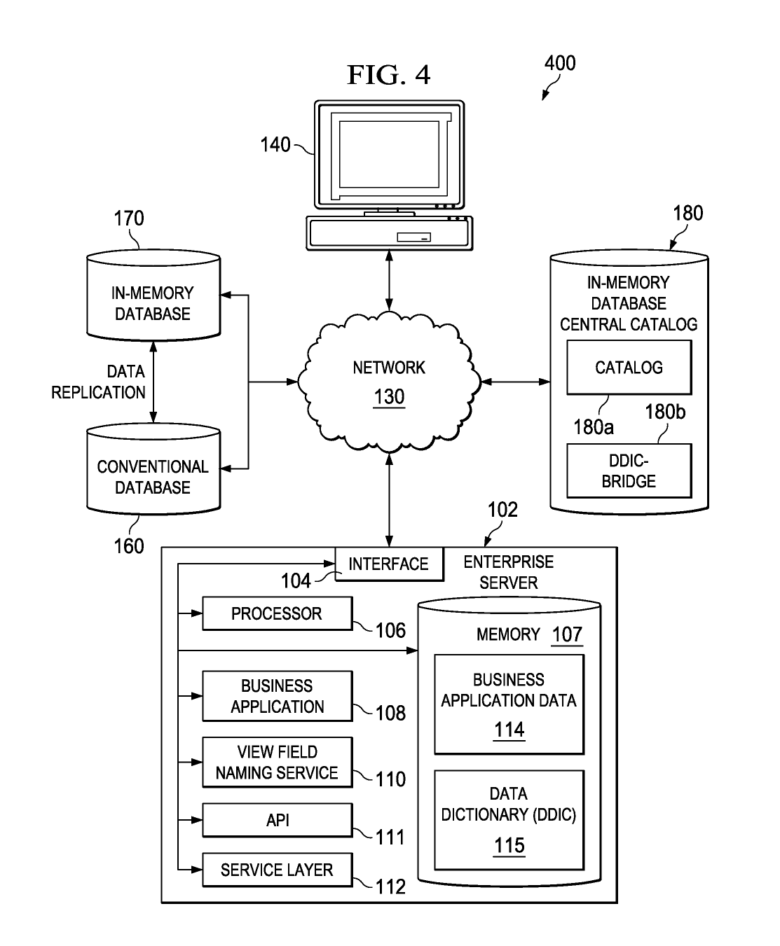

Turning now to FIG. 4, FIG. 4 is a block diagram 400 illustrating an enterprise server 102. At a high level, the enterprise server 102 comprises an electronic computing device operable to receive, transmit, process, store, or manage data and information associated with the example distributed computing system 100. For example, the enterprise server can be part of an enterprise resource planning (ERP) or a customer relationship management (CRM) system.

In general, the enterprise server 102 is a server that stores a business application 108 and a central catalog service 110, where at least a portion of the business application 108 and/or the central catalog service 110 is executed using requests and responses sent from/to a client 140 within and communicably coupled to the illustrated example distributed computing system 100 using network 130. In some implementations, the enterprise server 102 may store a plurality of various business applications 108. In other implementations, the enterprise server 102 may be a dedicated server meant to store and execute only a single business application 108. In some implementations, the enterprise server 102 may comprise a web server, where the business application 108 and/or central catalog service 110 represents one or more web-based applications accessed and executed by the client 140 using the network 130 or directly at the enterprise server 102 to perform the programmed tasks or operations of the business application 108 and/or the central catalog service 110.

Specifically, the enterprise server 102 is responsible for receiving application requests, for example business application 108 and/or central catalog service 110 requests, from one or more client applications associated with the client 140 of the example distributed computing system 100 and responding to the received requests by processing said requests in the associated business application 108 and/or central catalog service 110, and sending an appropriate response from the business application 108 and/or central catalog service 110 back to the requesting client application. In addition to requests from the client 140, requests associated with the business application 108 and/or central catalog service 110 may also be sent from internal users, external or third-party customers, other automated applications, as well as any other appropriate entities, individuals, systems, or computers. According to one implementation, enterprise server 102 may also include or be communicably coupled with an e-mail server, a web server, a caching server, a streaming data server, and/or other suitable server. In other implementations, the enterprise server 102 and related functionality may be provided in a cloud-computing environment.

As illustrated in FIG. 1, the enterprise server 102 includes an interface 104. Although illustrated as a single interface 104 in FIG. 1, two or more interfaces 104 may be used according to particular needs, desires, or particular implementations of the example distributed computing system 100. The interface 104 is used by the enterprise server 102 for communicating with other systems in a distributed environment—including within the example distributed computing system 100—connected to the network 130; for example, the client 140, the conventional database 160, the in-memory database 170, and/or the DCC 180, as well as other possible systems/components that may be communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

As illustrated in FIG. 1, the enterprise server 102 includes a processor 106. Although illustrated as a single processor 106 in FIG. 1, two or more processors may be used according to particular needs, desires, or particular implementations of the example distributed computing system 100. Generally, the processor 106 executes instructions and manipulates data to perform the operations of the enterprise server 102. Specifically, the processor 106 executes the functionality required to receive and respond to requests from, for example, the client 140 and/or other possible systems/components that may be communicably coupled to the network 130 (not illustrated), and to execute the business application 108 and/or central catalog service 110 functionality.

The enterprise server 102 also includes a memory 107 that holds data for the enterprise server 102. Although illustrated as a single memory 107 in FIG. 1, two or more memories may be used according to particular needs, desires, or particular implementations of the example distributed computing system 100. While memory 107 is illustrated as an integral component of the enterprise server 102, in alternative implementations, memory 107 can be external to the enterprise server 102 and/or the example distributed computing system 100.

The memory 107 holds data for the enterprise server 102. In some implementations, the memory 107 includes business application data 114 and a data dictionary (DDIC) 115. Although illustrated as single instances, there may be more than one instance of the business application data 114 and the DDIC 115.

The data dictionary 115 is a central, non-redundant, logical description/definition of all data objects used within systems/components of example distributed computing system 100, for example, the conventional database 160 and/or the in-memory database 170. Example data objects stored within the data dictionary 115 includes, for example, domains, data elements, and/or database table fields. For example, the data dictionary 115 shows how the data objects are mapped to an underlying relational database in tables or views which store business application data 114. New or modified data objects within the data dictionary 115 are available to all components associated with the systems/components of example distributed computing system 100. The data dictionary 115 also provides standard editing functions for editing data objects within the data dictionary 115. Although illustrated as stored on enterprise server 102, in other implementations, the DDIC 115 may be wholly or partially stored on the conventional database 160, the in-memory database 170, and/or the client 140.

At least one business application 108 is illustrated within the enterprise server 102. The business application 108 can be any application, program, module, process, or other software that may execute, change, delete, generate, or otherwise manage information associated with a particular enterprise server 102, and in some cases, a business process performing and executing business process-related events. In particular, business processes communicate with other users, applications, systems, and components to send and receive events. In some implementations, a particular business application 108 can operate in response to and in connection with at least one request received from an associated client 140. Additionally, a particular business application 108 may operate in response to and in connection with at least one request received from other business applications 108, including a business application 108 associated with another enterprise server 102 (not illustrated). In some implementations, each business application 108 can represent a Web-based application accessed and executed by remote clients 140 via the network 130 (e.g., through the Internet, or via at least one cloud-based service associated with the business application 108). For example, a portion of a particular business application 108 may be a Web service associated with the business application 108 that is remotely called, while another portion of the business application 108 may be an interface object or agent bundled for processing at a remote client 140. Moreover, any or all of a particular business application 108 may be a child or sub-module of another software module or enterprise application (not illustrated) without departing from the scope of this disclosure. Still further, portions of the particular business application 108 may be executed or accessed by a user working directly at the enterprise server 102, as well as remotely at a corresponding client 140. In some implementations, the enterprise server 102 can execute the business application 108.

Business application data 114 is any type of data associated with a data object used by the business application 108. For example, for a business application 108 that processes sales invoices, business application data 114 for a specific sales invoice data object may include data pertaining to a particular sales invoice number, buyer, seller, date, address, product(s), quantity, price, tax rate, etc. Although illustrated as stored on enterprise server 102, in other implementations, the business application data 114 may be wholly or partially stored on the conventional database 160, the in-memory database 170, and/or the client 140.

The service layer 112 provides software services to the enterprise server 102 and the example distributed computing system 100. The functionality of the enterprise server 102 may be accessible for all service consumers via this service layer. Software services, such as a central catalog service 110 (described below), provide reusable, defined business functionalities through a defined service interface. For example, the service interface may be software written in extensible markup language (XML) or other suitable language. While illustrated as an integrated component of the enterprise server 102 in the example distributed computing system 100, alternative implementations may illustrate the service layer 112 as a stand-alone component in relation to other components of the example distributed computing system 100. Moreover, any or all parts of the service layer 112 may be implemented as child or sub-modules of another software module or enterprise application (not illustrated) or of another hardware module (not illustrated) without departing from the scope of this disclosure.

The enterprise server 102 further includes a view field naming service 110. The view field naming service 110 is responsible for proposing names for an application view field. In some implementations, the view field naming service 110 interfaces with the service layer 112 to provide naming functionality to a service consumer, for example a client 140. In some implementations, the view field naming service 110 is made available to the client 140 by means of a plug-in, add-in, or other software. In some implementations, the view field naming service 110 runs continuously. In other implementations, the view field naming service 110 is triggered. For example, the view field naming service 110 could be triggered by a request received from the client application 146 through the service layer 112. In some implementations, view field naming service 110 communicates with the catalog 180a, the DDIC-bridge 180b, and the data dictionary 115.

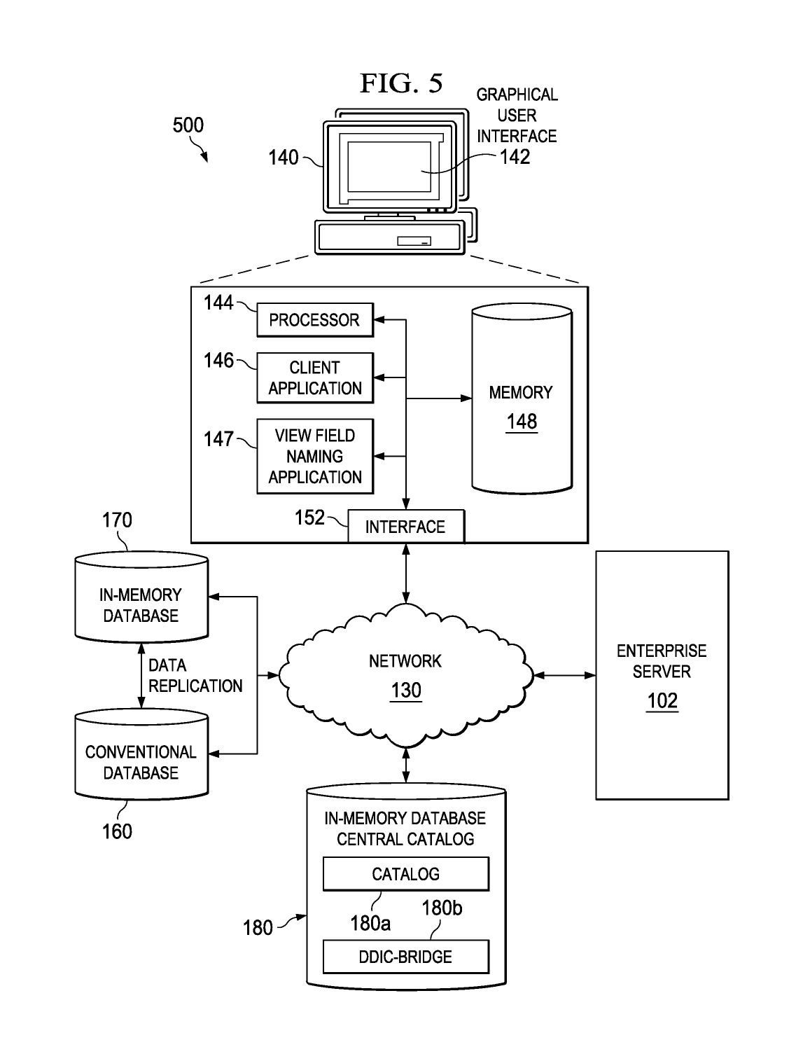

Turning now to FIG. 5, FIG. 5 is a block diagram 500 illustrating a client 140. The client 140 may be any computing device operable to connect to or communicate with at least the enterprise server 102 using the network 130. In general, the client 140 comprises an electronic computer device operable to receive, transmit, process, and store any appropriate data associated with the example distributed computing system 100.

The illustrated client 140 further includes a client application 146. The client application 146 is any type of application that allows the client 140 to request and view content on the client 140. In some implementations, the client application 146 can be and/or include a web browser. In some implementations, the client-application 146 can use parameters, metadata, and other information received at launch to access a particular set of data from the enterprise server 102. Once a particular client application 146 is launched, a user may interactively process a task, event, or other information associated with the business suite server 102. Further, although illustrated as a single client application 146, the client application 146 may be implemented as multiple client applications in the client 140.

In some implementations, the client application 146 can serve as a frontend modeling and administration GUI application for the in-memory database 170. The client application 146 functionality may provide, for example, load control and replication server/job management, loading of data from third-party database systems, manage connections to one or more enterprise servers 102, data model and business object modeling, and other suitable tasks applicable to the in-memory database 170. In some implementations, a connection to the in-memory database central catalog 180 is configured with a configuration setting in the client application 146.

The illustrated client 140 further includes a view field naming application 147. The view field naming application 147, similar to the view field naming service 110 described above, is responsible for proposing names for an application view field. In some implementations, the view field naming application 147 interfaces with the client application 146. The interface between the view field naming application 147 and the client application 146 may be facilitated by means of a plug-in, add-in, or other software. In some implementations, the view field naming application 147 runs continuously. In other implementations, the view field naming application 147 can be triggered. For example, the client application 146 could trigger the view field naming service 147 using a request. In some implementations, view field naming application 147 communicates with the catalog 180a, the DDIC-bridge 180b, and the data dictionary 115.

The illustrated client 140 further includes an interface 152, a processor 144, and a memory 148. The interface 152 is used by the client 140 for communicating with other systems in a distributed environment—including within the example distributed computing system 100—connected to the network 130; for example, the enterprise server 102, the conventional database 160, the in-memory database 170, and/or the DCC 180, as well as other possible systems/components that may be communicably coupled to the network 130 (not illustrated). The interface 152 may also be consistent with the above-described interface 104 of the enterprise server 102. The processor 144 may be consistent with the above-described processor 106 of the enterprise server 102. Specifically, the processor 144 executes instructions and manipulates data to perform the operations of the client 140, including the functionality required to send requests to the enterprise server 102, the conventional database 160, the in-memory database 170, and/or the DCC 180, as well as other systems/components communicably coupled to the network 130 (not illustrated) and to receive and process responses from the enterprise server 102, the conventional database 160, the in-memory database 170, and/or the DCC 180, as well as other possible systems/components that may be communicably coupled to the network 130 (not illustrated). The memory 148 may be consistent with the above-described memory 107 of the enterprise server 102. Specifically the memory 148 stores objects and/or data associated with the purposes of the client 140.

Further, the illustrated client 140 includes a GUI 142. The GUI 142 interfaces with at least a portion of the example distributed computing system 100 for any suitable purpose, including generating a visual representation of a web browser. In particular, the GUI 142 may be used to view and navigate various web pages located both internally and externally to the enterprise server 102, the conventional database 160, the in-memory database 170, and/or the DCC 180, as well as other systems/components communicably coupled to the network 130 (not illustrated).

There may be any number of clients 140 associated with, or external to, the example distributed computing system 100. For example, while the illustrated example distributed computing system 100 includes one client 140, alternative implementations of the example distributed computing system 100 may include multiple clients 140 communicably coupled to the enterprise server 102, the conventional database 160, the in-memory database 170, and/or the DCC 180, as well as other possible systems/components that may be communicably coupled to the network 130 (not illustrated), or any other number suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, this disclosure contemplates that one or many users may use one computer, or that one user may use multiple computers.

The illustrated client 140 is intended to encompass any computing device such as a workstation, desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the business suite server 102 or the client 140 itself, including digital data, visual information, or a GUI 142, as shown with respect to the client 140.

Turning now to FIG. 6, FIG. 6 is a flow chart 600 for providing a homogeneous data model based on in-memory database views. For clarity of presentation, the description that follows generally describes method 600 in the context of FIGS. 1-5. However, it will be understood that method 600 may be performed, for example, by any other suitable system, environment, software, and hardware, or a combination of systems, environments, software, and hardware as appropriate. For example, one or more of the business suite server, the client, or other computing device (not illustrated) can be used to execute method 600 and obtain any data from the memory of the client, the business suite server, or the other computing device (not illustrated).

At 602, a new application view is created or an existing application view is extended with a new application view field associated with a database field. In some implementations, a client uses a client application to create/extend an application view. From 602, method 600 proceeds to 604.

At 604, a database table is indicated as the base database table for the application view field. From 604, method 600 proceeds to 606.

At 606, a database field associated with the indicated base database table is indicated as the base database field for the application view field. From 606, method 600 proceeds to 608.

At 608, information about the indicated base database field is collected. Collected information may include, for example, the base database field name, a data element assigned to the base database field, and/or the domain assigned to the data element. At this point, the database table, database field, data element and domain associated with the indicated base database field are known. From 608, method 600 proceeds to 610.

At 610, a determination is made whether a catalog entry exists for the known domain, database field, or database element. If at 610, it is determined that a catalog entry does not exist, method 600 proceeds to 632. If at 610, however, it is determined that a catalog entry exists for the known domain, database field, or database element, method 600 proceeds to 612.

At 612, a determination is made whether an entry for only one of the domain, database field, or database element exists in the catalog. If at 610, it is determined that more than one catalog entry exists, for example an entry for both the domain and database element is found in the catalog, method 600 proceeds to 626. If at 612, however, it is determined that an entry for only one of the domain, database field, or database element exists in the catalog, method 600 proceeds to 614.

At 614 a name is proposed for the application view field by the view field naming service/application. From 614, method 600 proceeds to 616.

At 616, a determination is made whether the proposed name for the application view field is correct. If at 616, it is determined that the proposed name for the application view field is not correct, method 600 proceeds to 622. If at 616, however, it is determined that the proposed name for the application view field is correct, method 600 proceeds to 618.

At 618, a determination is made whether the proposed name for the application view field is accepted. If at 618, it is determined that the proposed name for the application view field is not accepted, method 600 proceeds to 622. If at 618, however, it is determined that the proposed name for the application view field is accepted, method 600 proceeds to 620.

At 620, the proposed name is applied to the application view field. After 620, method 600 stops.

At 622, a custom name is input for the application view field name, for example using a GUI on client 140. In some implementations, a custom name is limited to a format specified by naming rules. In some implementations, the naming rules may exist on the in-memory database central catalog or some other component of example distributed computing system 100. From 622, method 600 proceeds to 624.

At 624, a catalog entry is added for the proposed application view field name. In some implementations, the catalog entry can be added at either the domain or data element level. In other implementations, the catalog entry can be added at other levels. After 624, method 600 stops.

At 626, a proposal for the application view field name is made indicating one or more proposed names presented from least specific to most specific. For example, the one or more proposed names are associated with the domain (least specific), data element, field in table, or field in view (most specific). From 626, method 600 proceeds to 628.

At 628, an applicable view field name is chosen from the proposed names. In some implementations, the most specific applicable name for the application view field is chosen automatically. From 628, method 600 proceeds to 630.

At 630, the chosen view field name is applied to the application view field. After 630, method 600 stops.

At 632, a custom name is input for the application view field name, for example using a GUI on client 140. In some implementations, a custom name is limited to a format specified by naming rules. In some implementations, the naming rules may exist on the in-memory database central catalog or some other component of example distributed computing system 100. From 632, method 600 proceeds to 634.

At 634, a catalog entry is added for the custom application view field name. In some implementations, the catalog entry can be added at either the domain or data element level. In other implementations, the catalog entry can be added at other levels. After 634, method 600 stops.

Although the discussion above has focused on the use of an in-memory database, it is envisioned that conventional databases could be substituted for all in-memory databases without departing from the scope of this disclosure. For example, the method described in FIG. 6 could work equally well with both conventional and/or in-memory databases.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
creating an application view field associated with an application view;
indicating a base database field in a base database table for the created application view field;
collecting additional information associated with the indicated base database field;
determining at least a data element and a domain associated with the indicated base database field using the collected additional information;
determining, by operation of a computer using the collected additional information, that multiple catalog entries associated with the indicated base database field exist in a catalog, each catalog entry including both a proposed application view field name and a relationship to a particular data dictionary element type; and
proposing names for the application view field, wherein the proposed names are retrieved from the multiple catalog entries and presented from least specific to most specific.

2. The computer-implemented method of claim 1, wherein the collected additional information includes at least one of a name, a data element assigned to the indicated base database field name, or a domain assigned to the data element.

3. The computer-implemented method of claim 1, wherein the multiple catalog entries include a catalog entry for more than one of a domain, a database field, or a database element.

4. The computer-implemented method of claim 1, wherein, for the proposed names, most specific to least specific is in an order of field in view, field in table, data element, and domain.

5. The computer-implemented method of claim 1, further comprising choosing an applicable proposed name from the proposed names for the created application view field.

6. The computer-implemented method of claim 5, wherein the most specific proposed name is chosen as the applicable proposed name.

7. The computer-implemented method of claim 5, further comprising applying the chosen proposed name to the created application view field.

8. A computer-program product, the computer program product comprising computer-readable instructions embodied on tangible, non-transitory media, the instructions operable when executed to perform operations to:
create an application view field associated with an application view;
indicate a base database field in a base database table for the created application view field;
collect additional information associated with the indicated base database field;
determine at least a data element and a domain associated with the indicated base database field using the collected additional information;
determine, by operation of a computer using the collected additional information, that multiple catalog entries associated with the indicated base database field exist in a catalog, each catalog entry including a proposed application view field name and a relationship to a particular data dictionary element type; and
propose names for the application view field, wherein the proposed names are retrieved from the multiple catalog entries and are presented from least specific to most specific.

9. The computer-program product of claim 8, wherein the collected additional information includes at least one of a name, a data element assigned to the indicated base database field name, or a domain assigned to the data element.

10. The computer-program product of claim 8, wherein the multiple catalog entries include a catalog entry for more than one of a domain, a database field, or a database element.

11. The computer-program product of claim 8, wherein, for the proposed names, most specific to least specific is in an order of field in view, field in table, data element, and domain.

12. The computer-program product of claim 8, further comprising operations operable to choose an applicable proposed name from the proposed names for the created application view field.

13. The computer-program product of claim 12, wherein the most specific proposed name is chosen as the applicable proposed name.

14. The computer-program product of claim 12, further comprising operations operable to apply the chosen proposed name to the created application view field.

15. A system, comprising:
memory operable to store a base database; and
at least one hardware processor interoperably coupled to the memory and operable to:
create an application view field associated with an application view;
indicate a base database field in a table associated with the base database for the created application view field;
collect additional information associated with the indicated base database field;
determine at least a data element and a domain associated with the indicated base database field using the collected additional information;
determine, by operation of a computer using the collected additional information, that multiple catalog entries associated with the indicated base database field exist in a catalog, each catalog entry including a proposed application view field name and a relationship to a particular data dictionary element type; and
propose names for the application view field, wherein the proposed names are retrieved from the multiple catalog entries and are presented from least specific to most specific.

16. The system of claim 15, wherein the collected additional information includes at least one of a name, a data element assigned to the indicated base database field name, or a domain assigned to the data element.

17. The system of claim 15, wherein the multiple catalog entries include a catalog entry for more than one of a domain, a database field, or a database element.

18. The system of claim 15, wherein, for the proposed names, most specific to least specific is in an order of field in view, field in table, data element, and domain.

19. The system of claim 15, further operable to choose an applicable proposed name from the proposed names for the created application view field.

20. The system of claim 19, wherein the most specific proposed name is chosen as the applicable proposed name.

21. The system of claim 19, further operable to apply the chosen proposed name to the created application view field.

22. A computer-implemented method, comprising:
creating an application view field associated with an application view;
indicating a base database field in a base database table for the created application view field;
collecting additional information associated with the indicated base database field to determine at least a data element and a domain associated with the indicated base database field, wherein the collected additional information includes at least one of a name, a data element assigned to the indicated base database field name, or a domain assigned to the data element;
determining, by operation of a computer using the collected additional information, that multiple catalog entries associated with the indicated base database field exist in a catalog, each catalog entry including a proposed application view field name and a relationship to a particular data dictionary element type, and wherein the multiple catalog entries include a catalog entry for more than one of a domain, a database field, or a database element;
proposing names for the application view field, wherein the proposed names are retrieved from the multiple catalog entries and are associated with and presented from least specific to most specific in an order of field in view, field in table, data element, and domain;
choosing an applicable proposed name of the proposed names for the created application view field; and
applying the chosen proposed name to the created application view field.
